(19) United States
(12) Patent Application Publication
(10) Pub. No.: US 2014/0077096 A1
(43) Pub. Date: Mar. 20, 2014

(54) ELECTROSTATIC LENS UNIT

(71) Applicant: CANON KABUSHIKI KAISHA, Tokyo (JP)

(72) Inventors: Takashi Shiozawa, Tokyo (JP); Kazushige Utsumi, Sagamihara-shi (JP); Toshiro Yamanaka, Utsunomiya-shi (JP)

(21) Appl. No.: 14/023,308

(22) Filed: Sep. 10, 2013

(30) Foreign Application Priority Data
Sep. 14, 2012 (JP) 2012-202398

(51) Int. Cl. H01J 3/18

(52) U.S. Cl. CPC H01J 3/18
USPC 250/396 R

(57) ABSTRACT

An electrostatic lens unit of the present disclosure includes an electrostatic lens fixed to a fixing member. The electrostatic lens has a plurality of electrodes arranged apart from each other by a spacing member and each having a through hole through which a charged beam passes. The electrostatic lens is fixed to the fixing member at a position, on a side where the charged beam goes out, shifted from a center of a thickness of the electrostatic lens in a direction of an optical axis.

Part of a surface of the electrostatic lens on the side where the charged beam enters is connected to the fixing member via a supporting member.

### BACKGROUND OF THE INVENTION

1. Field of the Invention

The present disclosure relates to a technical field of an electro-optical system used in apparatuses in which a charged particle radiation such as an electron beam is employed and, more specifically, to an electrostatic lens unit used in an exposure apparatus.

2. Description of the Related Art

In an electron beam exposure apparatus, an electro-optical element for controlling electro-optical characteristics of an electron beam is utilized. Examples of an electron lens as the electro-optical element include an electromagnetic lens and an electrostatic lens. The electrostatic lens, in which a coil core is not required, is simple in configuration, and is easy to be reduced in size in comparison with the electromagnetic lens. There is known a multi-beam system which is one of electron beam exposure technologies configured to draw a pattern simultaneously with a plurality of electron beams without using a mask (WO2011/043668).

In association with enhancement of throughput of the exposure apparatus and enhancement of fineness of the exposure pattern, it is desired that the charged particle radiation exposure apparatus use high-density charged particle beams. However, when a wafer having a photosensitive resist applied thereon is irradiated with a high-density charged particle beam, an electrostatic lens generates heat due to reflected charged particles from the resist. The amount of thermal deformation of the electrostatic lens increases in accordance with the amount of generated heat, thereby causing out-of-focus of the charged particle beams or blurred images. Deformation of the electrostatic lens in the direction of an optical axis which contributes significantly to such problems cannot be corrected by a lens aperture pattern. In addition, deformation toward an exposure substrate has a risk of causing contact between the electrostatic lens and the exposure substrate.

### SUMMARY OF THE INVENTION

The present disclosure provides an electrostatic lens unit including:

an electrostatic lens and a fixing member configured to fix the electrostatic lens,

wherein the electrostatic lens includes a plurality of electrodes arranged apart from each other and each having a through hole through which a charged beam passes, and a spacing member arranged between the electrodes,

wherein the electrostatic lens is fixed to the fixing member at a position, on a side where the charged beam goes out, shifted from a center of a thickness of the electrostatic lens in a direction of an optical axis, and

wherein a part of a surface of the electrostatic lens on a side where the charged beam enters is connected to the fixing member via a supporting member.

Further features of the present invention will become apparent from the following description of exemplary embodiments with reference to the attached drawings.

### BRIEF DESCRIPTION OF THE DRAWINGS

FIGS. 1A to 1C are schematic diagrams for explaining an electrostatic lens unit according to a first embodiment.

FIGS. 2A and 2B are schematic diagrams for explaining an electrostatic lens unit according to a second embodiment.

FIGS. 3A to 3C are schematic diagrams for explaining an electrostatic lens unit according to Example 1.

FIGS. 4A and 4B are schematic diagrams for explaining an electrostatic lens unit according to Example 2.

### DESCRIPTION OF THE EMBODIMENTS

Referring to the drawings, embodiments of the present disclosure will be described in detail. In the respective drawings, a direction from an upper side (the side where a charged beam enters) to a lower side (the side where the charged beam goes out) of the paper plain is referred to as a downward direction, and a direction opposite thereto is referred to as an upward direction.

### First Embodiment

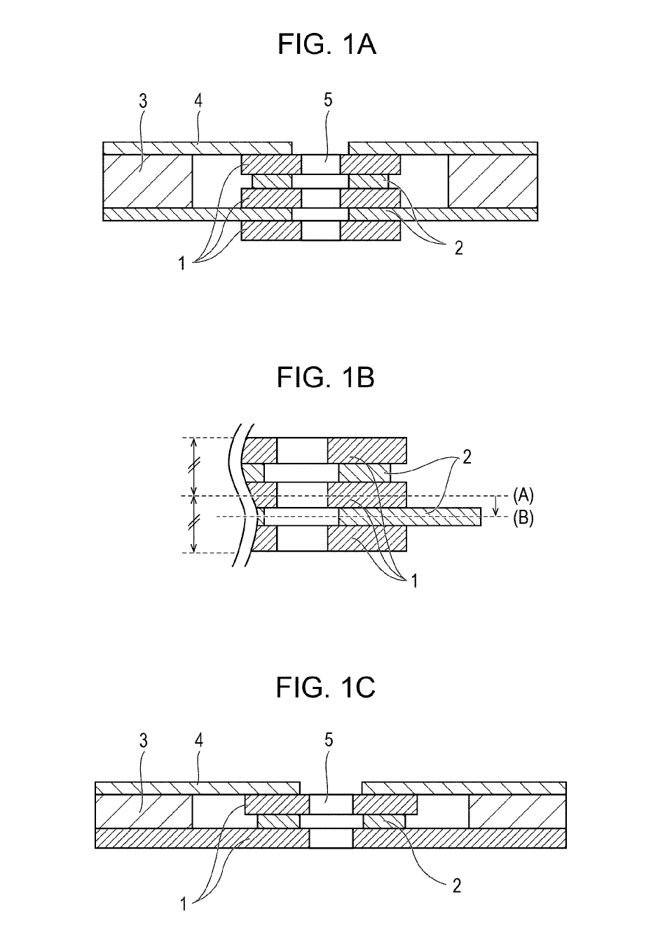

FIGS. 1A to 1C are a schematic cross-sectional view of a charged particle radiation lens (hereinafter referred to as an electrostatic lens) unit according to the first embodiment. The electrostatic lens includes two or more plate-shaped electrodes 1 arranged apart from each other and one or more plate-shaped spacing members 2 disposed therebetween and configured to define the distance between the electrodes. The electrodes 1 are formed of a metal or a semiconductor. The spacing member 2 is formed of glass or ceramic. A fixing member 3 is formed of a metal, a semiconductor, glass, or ceramic. A supporting member 4 is formed of a metal, a semiconductor, glass, or ceramic. As illustrated in FIG. 1A, the electrodes 1 and the spacing members 2 are formed with through holes 5 through which a charged beam passes. The charged beam is discharged from a charged particle radiation source, not illustrated, and composed of charged particles. Through hole arrays composed of a plurality of through holes formed in the electrodes 1 are arranged inside the single through hole of each of the spacing members 2. A resist, not illustrated, is irradiated with electrons passed through the through holes 5. Here, for example, when the potentials of the two electrodes 1 at both ends are maintained at an earth potential and a negative voltage is applied to an intermediate electrode, this lens functions as an einzel lens.

As illustrated in FIG. 1B, the fixing member 3 is fixed to the spacing member 2 at a position (B) shifted downward from a center position (A) of the thickness of the electrostatic lens in the direction of the optical axis. When heat is generated in the electrostatic lens by a reflected charged particle radiation from the resist, the electrostatic lens may be deformed. However, since the electrostatic lens is fixed to the supporting member 4 in the downward direction from the center position, deformation of the electrostatic lens occurs in the upward direction. In other words, the direction of deformation of the electrostatic lens in the optical axis direction may be defined to the upward direction. In addition, since the supporting member 4 has a function to hold the deformed electrostatic lens from the upper side, the deformation itself is also suppressed. The supporting member 4 and the electrodes 1 may be connected directly, or may be connected indirectly with another member interposed therebetween. The supporting member 4 and the electrodes 1 may be connected by bonding or contacting. The supporting member 4 is preferably formed of a material having an elastic modulus larger than that of the spacing member 2 to be fixed to the fixing member 3. At this time, since the lens deformed in the upward direction may be held by the supporting member 4 connected to the fixing member 3, the amount of deformation of the electrostatic lens in the direction of the optical axis may further be suppressed. In the description, a mode in which three of the electrodes 1 are provided has been described. However, even in a case where there are two of the electrodes 1 (immersion lens) as illustrated in FIG. 1C, the same effect is achieved if the lower electrode 1 and the fixing member 3 are fixed.

### Second Embodiment

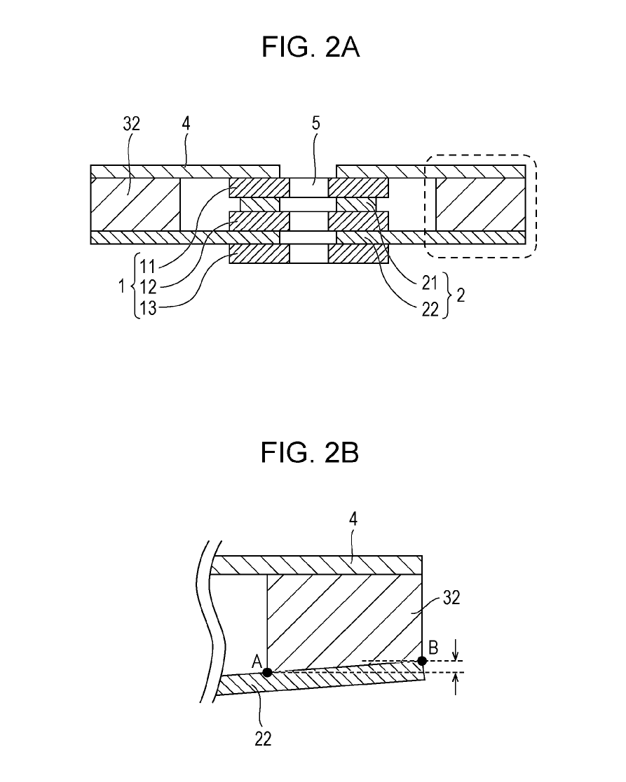

FIG. 2A is a cross-sectional view of an electrostatic lens of a second embodiment. FIG. 2B is an enlarged view of an area surrounded by a broken line in FIG. 2A. As illustrated in FIG. 2B, the bottom surface of a fixing member 32 (the surface connected to a spacing member 22) is inclined in advance with respect to a horizontal plane (a plane having a normal line coincident with the optical axis). The electrostatic lens has a strain originated from a point A. If the point A is located on an upper side of a point B, the electrostatic lens is deformed into an upward projecting shape, and if the point A is located on a lower side of the point B, the electrostatic lens is deformed into a downward projecting shape. By applying the strain caused by the deformation of the electrostatic lens in the direction opposite to the direction of thermal deformation by the reflected charged particles, the amount of deformation of the lens caused by a heat generation is cancelled. Therefore, the amount of deformation of the electrostatic lens may further be suppressed. For example, in the case of the einzel lens illustrated in FIG. 2A, an upward force acts on the electrostatic lens by the heat generation. In contrast, as illustrated in FIG. 2B, the point A on the side farther from the fixing member 32 is positioned on the bottom side, so that the strain in the downward direction may be applied to the electrostatic lens. Accordingly, the deformation in the direction of the optical axis caused by the heat generation may be alleviated. Here, a curvature factor may be applied to part or the whole of the fixing member 3 instead of providing the fixing member 3 with an inclination.

### Third Embodiment

Although the basic configuration is the same as the first embodiment, the connection between the supporting member 4 and an electrode 11 is achieved by bonding. When the supporting member 4 and the electrode 11 are connected directly, the same material as the electrode 11 is selected and used for the supporting member 4. In contrast, when an intermediate member (not illustrated) is interposed therebetween, a material having a coefficient of linear expansion larger than that of the intermediate member is selected and used for the supporting member 4. When the electrostatic lens generates heat, the heat is transferred to the supporting member 4 via the lens. The supporting member 4, and the electrode 11 or the intermediate member are thermally expanded in the horizontal direction. However, the supporting member 4 expands to a larger extent due to the difference in coefficient of linear expansion (linear expansion coefficient). At this time, since the both materials are bonded, a bending moment is generated at an interface, and a stress acts in the direction opposite to the defined direction of thermal expansion. In other words, a force is applied in a direction of holding the electrostatic lens so as not to be deformed, and hence the deformation of the electrostatic lens is suppressed.

### EXAMPLES

Detailed examples on the basis of the respective embodiments described above will be described.

### Example 1

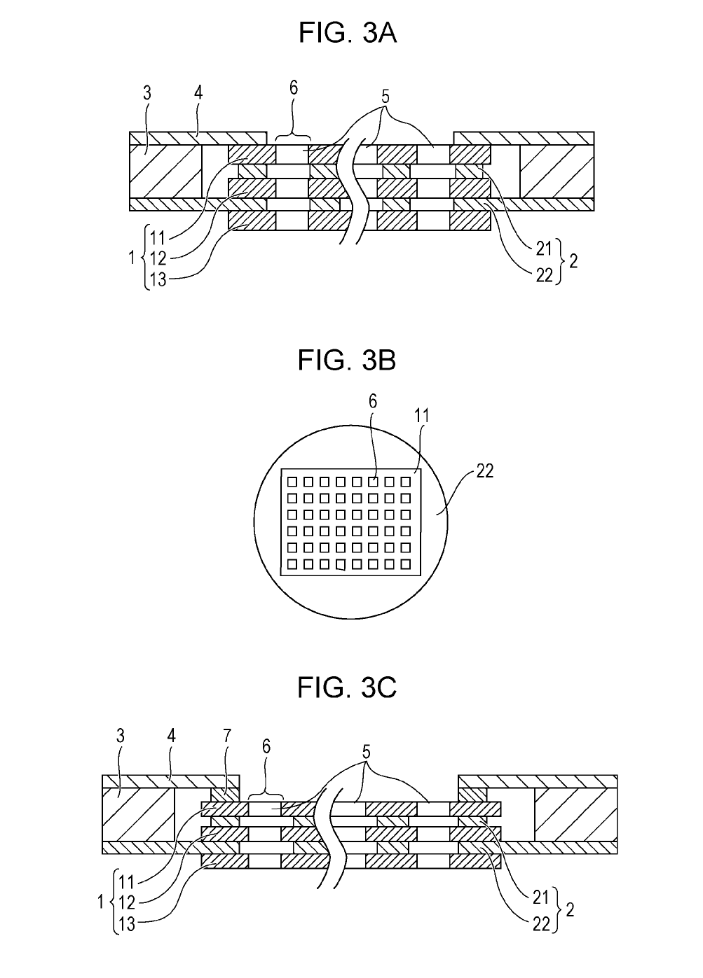

FIGS. 3A to 3C are schematic drawings of an electrostatic lens unit according to Example 1. The electrodes 1 are rectangular silicon plates each having a thickness of 100 μm and a size of 55 mm×72 mm. A spacing member 21 from among the spacing members 2 is a rectangular borosilicate glass having a thickness of 400 μm and a size of 55 mm×72 mm, and the spacing member 22 is a disc-shaped borosilicate glass having a diameter of 101.6 mm. The fixing member 3 is a disc-shaped aluminum oxide having a diameter of 101.6 mm and a thickness of 600 μm, and has an opening of 59 mm×76 mm at a center thereof. The supporting member 4 is a disc-shaped silicon substrate having a diameter of 101.6 mm and a thickness of 300 μm, and has an opening of 51 mm×68 mm at a center thereof. FIG. 3B illustrates the electrodes 1 and the spacing members 2 bonded together and viewed from above. In Example 1, sub arrays 6 including a plurality of through holes in each of the electrodes 1 and a single through hole in each of the spacing members 2 are arranged at intervals of 8.5 μm in 6×8 in a square grid shape. In the single sub-array, the through holes 5 each have an opening diameter of 30 μm in the electrodes 1, and are arranged at intervals of 50 μm in a square grid pattern. In the spacing members 2, the opening has a size of 4.5 mm×4.5 mm.

A method of manufacturing the electrostatic lens unit according to Example 1 will be described. In the electrodes 1, the through holes 5 were formed in the silicon substrate by highly accurate photolithography and dry etching. In the spacing members 2, the through holes 5 were formed by a sand blast process and micro crack and burr on the surface of the machined surface are treated by wet etching and surface polishing. Subsequently, three of the electrodes 1 and the spacing members 2 subjected to the process described above were alternately bonded in sequence from the electrode 1 with the axes of the through holes 5 aligned. Bonding was achieved by using a silicone-based bonding agent having heat resistance. Subsequently, after the fixing member 3 and the spacing member 22 were fixed by bonding, the supporting member 4 was bonded to the electrode 11 and the fixing member 3. The bonding was achieved by a silicone-based bonding agent having heat resistance. With the procedure described thus far, a configuration illustrated in FIG. 3A was obtained.

### Example 2

Example 2 is the same electrostatic lens unit as that in Example 1 and a method of manufacturing the same except for points described below. As illustrated in FIG. 3C, a second supporting member 7 is provided between the supporting member 4 and the electrode 11 in Example 2. The second supporting member 7 was a rectangular frame member formed of a rectangular silicon plate having a thickness of 200 μm and a size of 55 mm×72 mm formed with an opening of 51 mm×68 mm, and was bonded to the electrode 11 by using a silicone-based adhesive agent having heat resistance. When bonding the supporting member 4 and the fixing member 3, and the supporting member 4 and the second supporting member 7, respectively, a configuration illustrated in FIG. 3C is obtained. The thickness of the fixing member 3 at this time was 800 μm.

### Example 3

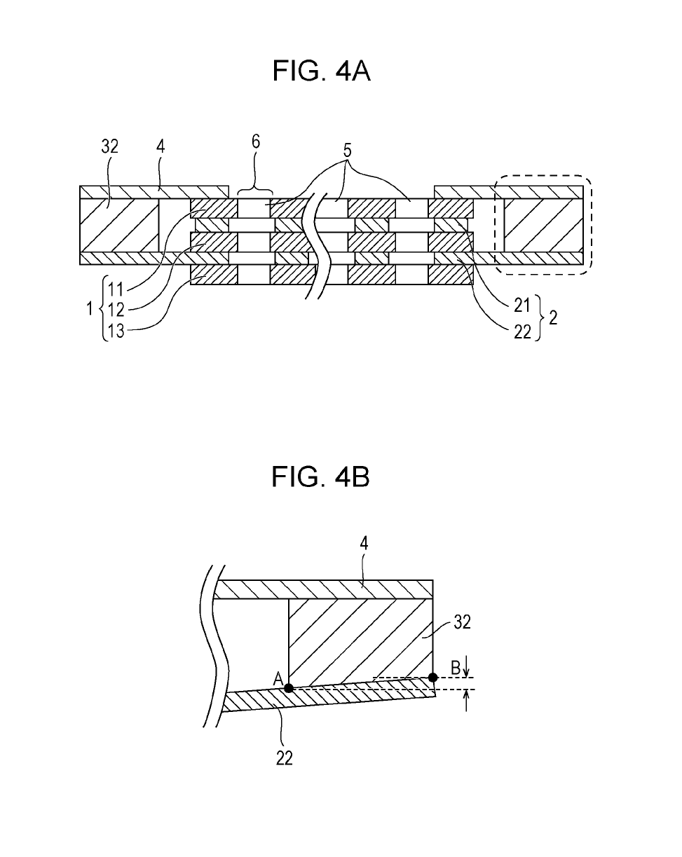

Example 3 is the same electrostatic lens unit as that in Example 1 and a method of manufacturing the same except for points described below. As illustrated in FIG. 4B that is an enlarged view of an area surrounded by a broken line in FIG. 4A, surface polishing was performed on a bottom surface of the fixing member 32, and an AB plane was provided with an inclination of 0.5 degree from the horizontal direction with respect to the optical axis. The fixing member 32 and the spacing member 22 were bonded by using the silicone-based adhesive agent having heat resistance. When the supporting member 4 and the fixing member 32, and the supporting member 4 and the electrode 11 are bonded respectively, the configuration illustrated in FIG. 4A was achieved.

### Example 4

Example 4 is the same electrostatic lens unit as that in Example 1 and a method of manufacturing the same except for points described below. In Example 4, copper was employed as the material of the supporting member 4. Copper is a material having a coefficient of linear expansion larger than silicon that is the material of the electrodes 1 (see Table 1).

TABLE 1
COEFFICIENT OF LINEAR EXPANSION

| | 20° C., under 1 atm [×10⁻⁶/° C.] |
|---|---|
| Pure Copper | 16.5 |
| Silicon | 2.8 to 7.3 |

### Example 5

Example 5 is the same electrostatic lens unit as that in Example 2 and a method of manufacturing the same except for points described below. In Example 5, copper, which is a material having a coefficient of linear expansion larger than silicon that is the material of the second supporting member 7 was employed as the material of the supporting member 4.

In the respective examples described above, the electrode 11 and an electrode 13 were actually maintained at an earth potential, and −3.7 kV was applied to an electrode 12, and an electron beam was passed through the through holes 5, and the resist was exposed. Consequently, drawing of a clear pattern with less blur was achieved.

According to the electrostatic lens unit of this disclosure, the direction of deformation of the electrostatic lens along the optical axis may be defined toward the charged particle radiation source, and the deformation of the electrostatic lens may be suppressed by the supporting member arranged on the charged particle radiation source side. Therefore, the amount of deformation of the electrostatic lens in the direction of the optical axis may be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-202398, filed Sep. 14, 2012, which is hereby incorporated by reference herein in its entirety.

What is claimed is:

1. An electrostatic lens unit comprising:
an electrostatic lens and a fixing member configured to fix the electrostatic lens,
wherein the electrostatic lens includes a plurality of electrodes arranged apart from each other and each having a through hole through which a charged beam passes, and a spacing member arranged between the electrodes,
wherein the electrostatic lens is fixed to the fixing member at a position, on a side where the charged beam goes out, shifted from a center of a thickness of the electrostatic lens in a direction of an optical axis, and
wherein a part of a surface of the electrostatic lens on a side where the charged beam enters is connected to the fixing member via a supporting member.

2. The electrostatic lens unit according to claim 1, wherein the supporting member is connected to an electrode located closest to the side where the charged beam enters.

3. The electrostatic lens unit according to claim 1, wherein each electrode includes a plurality of through holes, and the spacing member includes a single through hole, and
wherein the plurality of through holes of the electrode are arranged inside the single through hole of the spacing member.

4. The electrostatic lens unit according to claim 1, wherein an elastic modulus of the supporting member is larger than an elastic modulus of the spacing member.

5. The electrostatic lens unit according to claim 1, wherein each electrode is formed of silicon and the spacing member is formed of glass.

6. The electrostatic lens unit according to claim 4, wherein the supporting member is formed of silicon and the fixing member is formed of aluminum oxide.

7. The electrostatic lens unit according to claim 1, wherein a surface of the fixing member connected to the electrode or the spacing member has an inclination or a curvature factor with respect to a plane having a normal line coincident with the optical axis.

8. The electrostatic lens unit according to claim 1, wherein the supporting member is connected to the electrode via an intermediate member, and the supporting member has a linear expansion coefficient higher than a linear expansion coefficient of the intermediate member.
